(19) United States
(12) Patent Application Publication
(10) Pub. No.: US 2017/0024861 A1
(43) Pub. Date: Jan. 26, 2017

(54) VEHICLE-MOUNTED DISPLAY DEVICE, METHOD FOR CONTROLLING VEHICLE-MOUNTED DISPLAY DEVICE, AND NON-TRANSITORY COMPUTER READABLE MEDIUM RECORDING PROGRAM

(71) Applicant: Panasonic Intellectual Property Management Co., Lt, Osaka (JP)

(72) Inventors: KOJI ARATA, Kanagawa (JP); WATARU NAKAI, Tokyo (JP); YUKO ARAI, Tokyo (JP)

(21) Appl. No.: 15/286,685

(22) Filed: Oct. 6, 2016

Related U.S. Application Data
(63) Continuation of application No. PCT/JP2015/002160, filed on Apr. 21, 2015.

(30) Foreign Application Priority Data
Apr. 24, 2014 (JP) 2014-089752

(51) Int. Cl. G06T 5/00; G06T 5/20; H04N 5/232; G06T 7/00; B60R 1/00; B60K 35/00

(52) U.S. Cl. CPC G06T 5/002; B60R 1/00; B60K 35/00; H04N 5/23229; G06T 7/0083; G06T 5/20; B60R 2300/307; B60R 2300/8046; G06T 2207/20144; G06T 2207/30252

(57) ABSTRACT

A vehicle-mounted display device includes a background identifier, a background processor, and a display unit. The background identifier specifies the background of a camera image captured by a camera mounted in the vehicle based on the vanishing point in the camera image. The background processor performs background processing to reduce the clarity of the background specified by the background identifier. The display unit displays the camera image background-processed by the background processor.

### BACKGROUND

1. Technical Field

The present disclosure relates to a vehicle-mounted display device which allows the driver to see images captured by a camera mounted in a vehicle.

2. Background Art

Vehicle-mounted display devices are growing in popularity which process images captured by a camera mounted in a vehicle and show the processed images to the driver so as to support safe driving.

In well-known conventional vehicle-mounted display devices, an image behind the vehicle captured by the camera is shown while the display range is changed according to the speed of the vehicle so that the displayed image can draw the driver's attention (see, for example, Japanese Translation of PCT Publication No. 2005-515930).

### SUMMARY

The present disclosure provides a vehicle-mounted display device which image-processes the background of images captured by a camera and then shows mobile objects with high visibility.

The vehicle-mounted display device of the present disclosure includes a background identifier, a background processor, and a display unit. The background identifier specifies the background of a camera image captured by the camera mounted in the vehicle based on the vanishing point in the camera image. The background processor performs background processing to reduce the clarity of the background specified by the background identifier. The display unit displays the camera image background-processed by the background processor. The term “background” means objects moving away from a vehicle mounted with the vehicle-mounted display device (hereinafter, referred as an own vehicle) as the own vehicle travels. The background processing to reduce the clarity includes the process of eliminating the background from the camera image.

The vehicle-mounted display device of the present disclosure shows mobile objects with high visibility by reducing the clarity of the background specified in a camera image. The term “mobile objects” means objects other than the background.

### BRIEF DESCRIPTION OF DRAWINGS

FIG. 1 is a block diagram showing the configuration of a vehicle-mounted display device according to a first exemplary embodiment of the present disclosure.

FIG. 2 is a flowchart of an example of an operation of a background identifier in the first exemplary embodiment of the present disclosure.

FIGS. 3A to 3E show various examples of process of the background identifier in the first exemplary embodiment of the present disclosure.

FIGS. 4A to 4C show various examples of process of a background processor in the first exemplary embodiment of the present disclosure.

FIG. 5 is a block diagram showing the configuration of a vehicle-mounted display device according to a second exemplary embodiment of the present disclosure.

FIG. 6 is a flowchart of an example of an operation of a background identifier in the second exemplary embodiment of the present disclosure.

FIGS. 7A to 7C show various examples of process of the background identifier in the second exemplary embodiment of the present disclosure.

FIGS. 8A to 8C show various examples of process of a background processor in the second exemplary embodiment of the present disclosure.

FIG. 9 is a block diagram showing the configuration of a vehicle-mounted display device according to a third exemplary embodiment of the present disclosure.

FIG. 10 is a flowchart of an example of an operation of a background identifier in the third exemplary embodiment of the present disclosure.

FIGS. 11A and 11B show examples of search range determined based on vehicle speed by the background identifier in the third exemplary embodiment of the present disclosure.

### DETAILED DESCRIPTION OF PREFERRED EMBODIMENTS

Prior to describing exemplary embodiments of the present disclosure, problems of conventional vehicle-mounted display devices will now be described in brief. In any of the conventional vehicle-mounted display devices, the display range of images is changed according to the speed of the own vehicle. Therefore, even when an image captured by the camera shows mobile objects approaching the own vehicle, the mobile objects may not appear on the display. Thus, the conventional devices do not take the visibility of mobile objects into full consideration.

The exemplary embodiments of the present disclosure will now be described as follows with reference to drawings. Note that the following exemplary embodiments are merely preferable examples of the disclosure. The values, shapes, components, the arrangement and connection of the components, and other conditions used in the exemplary embodiments are mere examples and do not limit the disclosure.

### First Exemplary Embodiment

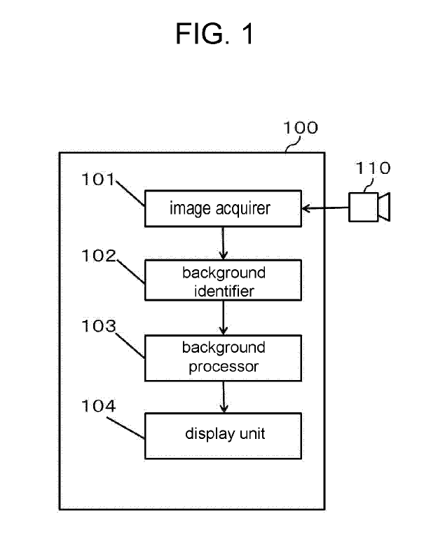

FIG. 1 is a block diagram showing the configuration of vehicle-mounted display device 100 according to a first exemplary embodiment of the present disclosure.

Vehicle-mounted display device 100 is connected to camera 110 mounted in the vehicle configured to capture images behind the vehicle. Image acquirer 101 acquires a camera image captured by camera 110, and transforms it into a perspective projection image after, if necessary, correcting the distortion of the camera image.

Background identifier 102 specifies the background of the camera image using the vanishing point. The vanishing point is a point where parallel lines in the real world converge in the image. In the present disclosure, the point where a pair of parallel lines coinciding with the direction of travel of the vehicle converges in the image is referred to as the vanishing point in the camera image. The vanishing point in a camera image can be determined by various well-known methods, such as using an internal parameter (for example, distortion coefficient) of the camera, an external parameter (for example, the installation angle of the camera with respect to the vehicle), or an optical flow technique. The vanishing point is determined at the time of installing the camera.

The term “background” means objects in a camera image that are moving away from the own vehicle as the own vehicle travels. Examples of the objects include vehicle traffic markings and buildings along the road (carriage way).

The detailed process of background identifier 102 will be described later with reference to drawings.

Background processor 103 performs background processing, which reduces the clarity of the background specified by background identifier 102. The background processing can be, for example, to reduce the high-frequency components using a low-pass filter or to reduce the contrast by adjusting the gradation.

Display unit 104 displays the camera image background-processed by background processor 103. Display unit 104 can be, for example, a liquid crystal display and is installed in the rearview mirror position inside the vehicle.

The operation of background identifier 102 will now be described with reference to drawings.

Background identifier 102 sets a reference position on a camera image acquired by image acquirer 101, and then determines whether the slope of the edge of the reference position agrees with the slope of the straight line passing through the reference position and the vanishing point. When these slopes agree with each other, the reference position is determined to be the background.

The term “edge” used in the present exemplary embodiment means a group of pixels composing the contour of an object shown in the camera image. When the line connecting adjacent or nearby pixels of the edge is regarded as a line segment, the slope of the line segment is referred to as the slope of the edge.

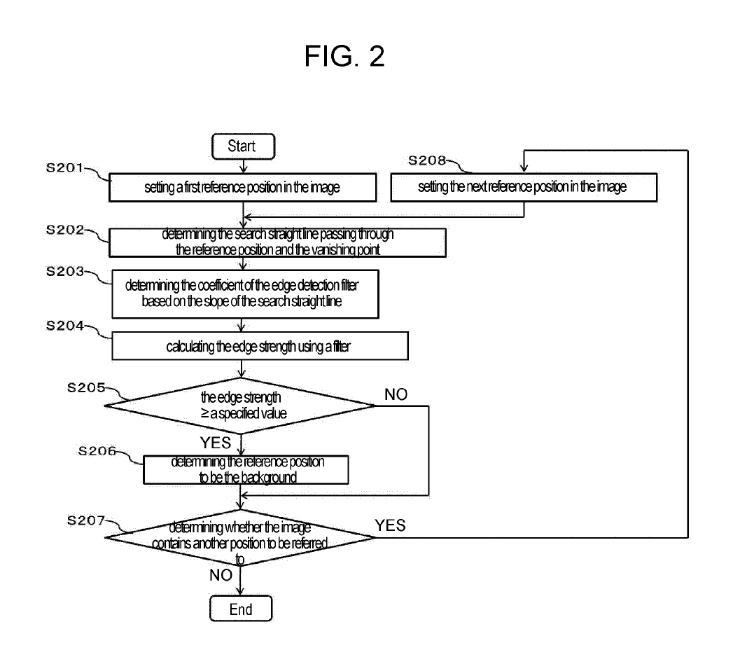

FIG. 2 is a flowchart of the operation of background identifier 102 in the first exemplary embodiment.

Background identifier 102 sets a first reference position in the camera image (Step S201). The term “reference position” means the position of the pixel as the target to determine whether it is the background or not in the camera image. The reference position is set for all pixels from the upper left pixel to the lower right pixel, in order of, for example, from left to right, and from top to bottom.

Background identifier 102 determines the straight line to search the background (hereinafter, the search straight line) based on each of the reference positions as set above and the position of the vanishing point (Step S202). Background identifier 102 then determines the coefficient of the edge detection filter based on the slope of the search straight line (Step S203). The coefficient of the filter is determined in such a manner as to extract the edge whose slope agrees with the slope of the search straight line.

Background identifier 102 then calculates the edge intensity at each reference position using the edge detection filter (Step S204). The term “edge intensity” is an index to determine whether the pixel is an element of the edge having a specific slope. When the calculated edge intensity is not less than a specified value (YES in Step S205), background identifier 102 determines the reference position to be the background (Step S206). Meanwhile, when the calculated edge intensity is lower than the specified value (NO in Step S205), the process proceeds to Step S207. Background identifier 102 normalizes the edge intensity between 0 and 1, and determines the reference position showing an edge intensity of not less than 0.7 to be the background.

Background identifier 102 then stores the reference positions determined to be the background in a storage unit (not shown) contained in background identifier 102.

In Step S206, the determination of whether the reference position is the background or not is completed.

When the camera image acquired by image acquirer 101 contains no other position to be referred to (NO in Step S207), background identifier 102 terminates the background specification process which is based on the vanishing point.

Meanwhile, when the camera image contains another position to be referred to or another pixel as the target to determine whether it is the background or not (YES in Step S207), background identifier 102 sets a next reference position in the camera image, for example, according to the above-described order (Step S208), and repeats the processes from Step S202.

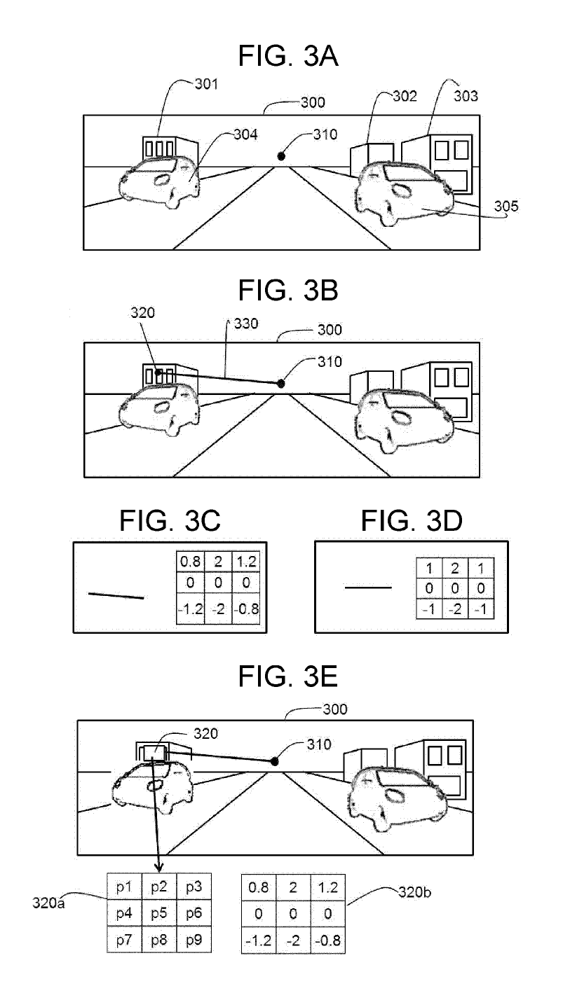

FIGS. 3A to 3E show processes of background identifier 102.

FIG. 3A shows a camera image acquired by image acquirer 101. This image is captured by the camera installed at the back of the vehicle (own vehicle) driving in the middle lane of a three-lane road. Camera image 300 contains buildings 301, 302, and 303 and vehicles 304 and 305. Vehicles 304 and 305 are traveling behind the own vehicle. Camera image 300 has vanishing point 310, which is specified at the time of installing the camera into the vehicle.

Camera image 300 is supplied to background identifier 102. FIG. 3B shows camera image 300 containing reference position 320 set by background identifier 102. Background identifier 102 determines whether or not reference position 320 is the background using vanishing point 310.

Background identifier 102 calculates search straight line 330, which passes through reference position 320 and vanishing point 310. Background identifier 102 then determines the coefficient of the edge detection filter based on the slope of the search straight line. The coefficient of the filter is determined in such a manner as to detect the edge whose slope agrees with the slope of search straight line 330.

FIG. 3C shows an example of the coefficient of the edge detection filter with respect to search straight line 330 shown in FIG. 3B. FIG. 3D shows an example of the coefficient of the edge detection filter when the search straight line is horizontal. In order to detect the edge whose slope agrees with the slope of the search straight line, background identifier 102 calculates the edge intensity using one of different edge detection filters for each of the search straight lines having a slope different from each other.

FIG. 3E shows a calculation example of the edge intensity. Pixel values 320a are those of reference position 320 and its nearby positions. The pixel value p5 represents that of reference position 320. Background identifier 102 calculates the edge intensity of the reference position using pixel value 320a extracted from the reference position and its nearby positions, and edge detection filter 320b. The sum of the products of the pixel values and the coefficients of the corresponding edge detection filters is calculated as the edge intensity. In FIG. 3E, background identifier 102 calculates the edge intensity=|p1×0.8+p2×2.0+p3×1.2+ . . . +p9×(−0.8)|.

Background identifier 102 normalizes the edge intensity, for example, between 0 and 1, and determines the reference position of an edge intensity of not less than 0.7 to be the background. Background identifier 102 then stores the reference position.

Background identifier 102 calculates the edge intensities of all pixels in the camera image by regarding the pixels as reference positions, thereby specifying the background.

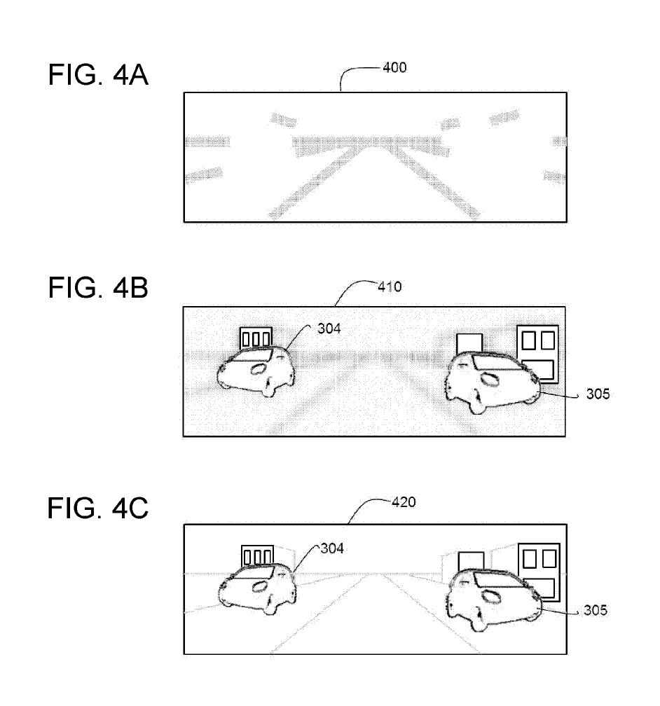

FIGS. 4A to 4C show processes of background processor 103.

FIG. 4A shows the background specified by background identifier 102. Background identifier 102 stores the reference positions determined to be the background in the storage unit (not shown). The gray regions in image 400 represent the background regions in the camera image stored by background identifier 102.

Background processor 103 applies background processing to the background specified by background identifier 102 so as to reduce the clarity of the background. Background processor 103 reduces the high-frequency components using a low-pass filter or reduces the contrast by adjusting the gradation, as the background processing, for example.

FIG. 4B shows camera image 410 obtained by reducing the high-frequency components in the background regions shown in FIG. 4A using a low-pass filter. FIG. 4C shows camera image 420 obtained by adjusting the gradation of the background regions shown in FIG. 4A, thereby reducing the contrast of the background regions.

Display unit 104 displays background-processed camera image 410 or 420.

As shown in FIGS. 4A to 4C, the edges which exist on the straight line passing through the vanishing point and have slopes agreeing with the slope of the straight line are the contours of vehicle traffic markings, curbs, and the lateral sides of buildings along the road. Reducing the clarity of these edges results in highlighting vehicles 304 and 305, which could be at risk of crashing into the own vehicle. The edges of the front sides of the buildings along the road remain as clear as ever. However, the driver is unlikely to recognize them as buildings because the clarity of the edges of the lateral sides of the buildings is reduced.

The determination of the background by background identifier 102 is performed pixel by pixel, so that the background regions can be specified up to the outline of mobile object regions.

As a result, in both camera images 410 and 420, background processor 103 reduces the clarity of the background, thereby increasing the visibility of vehicles 304 and 305 as the mobile objects.

As described above, vehicle-mounted display device 100 includes background identifier 102, background processor 103, and display unit 104. Background identifier 102 specifies the background of a camera image captured by camera 110 mounted in the vehicle based on the vanishing point of the camera image. Background processor 103 performs background processing to reduce the clarity of the background specified by background identifier 102. Display unit 104 displays the camera image background-processed by background processor 103. Background identifier 102 determines the edge which exists on the straight line passing through the vanishing point and has a slope agreeing with the slope of the straight line to be the background. Background processor 103 reduces the clarity of the background, thereby increasing the visibility of mobile objects.

The above-described examples of the background processing are to reduce the high-frequency components using a low-pass filter and to reduce the contrast by adjusting the gradation. However, background processing is not limited thereto. Besides these methods, the background processing can be any processing to reduce the clarity of the background, such as mosaicing. Alternatively, eliminating the background from the camera image is acceptable.

The method of setting a reference position is not limited to that described in the exemplary embodiments. Alternatively, a next reference position can be set along the straight line passing through the present reference position and the vanishing point.

The edge intensity can be calculated not for all the pixels in the camera image, but for some of the pixels, such as the odd-numbered pixels or the pixels on the odd-numbered lines.

Vehicle-mounted display device 100 can be achieved by dedicated hardware implementation. Alternatively, however, it is possible to store a program to implement the function in a computer-readable recording medium, to read the stored program into computer system, and to execute it.

### Second Exemplary Embodiment

A vehicle-mounted display device according to a second exemplary embodiment of the present disclosure will now be described as follows.

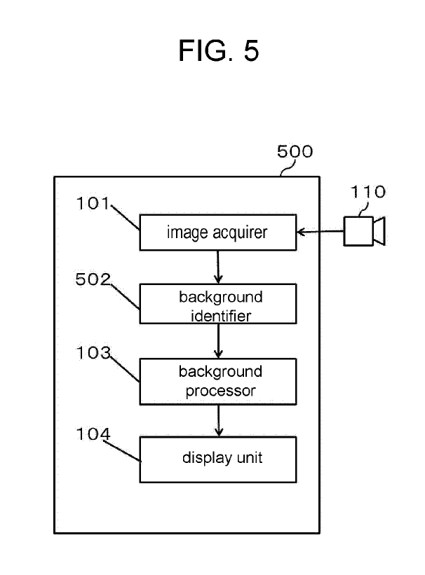

FIG. 5 is a block diagram showing the configuration of vehicle-mounted display device 500 according to the present exemplary embodiment.

In the present exemplary embodiment, the same components as in the first exemplary embodiment are denoted by the same reference numerals, and thus a detailed description thereof is omitted.

The second exemplary embodiment differs from the first exemplary embodiment in that the second exemplary embodiment includes background identifier 502, which specifies the background based on two camera images captured at different timings.

Background identifier 502 determines a second pixel to be the background. The second pixel has a correlation of not less than a given value with a first pixel existing on the straight line passing through the vanishing point in a first camera image captured at a first timing. In a second camera image captured later than the first timing, the second pixel is at a position shifted to the vanishing point from the position of the first pixel on the straight line passing through the pixel corresponding to the first pixel and the vanishing point.

The operation of background identifier 502 will now be described with reference to drawings.

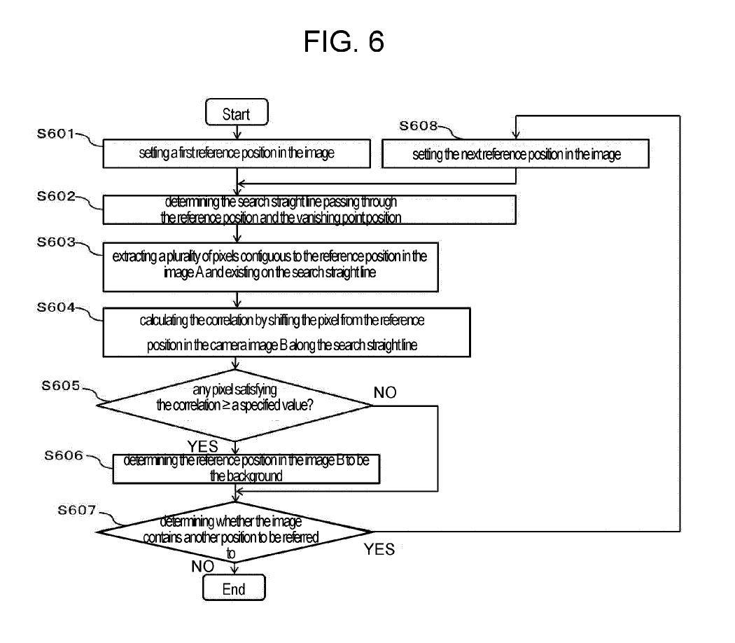

FIG. 6 is a flowchart of the operation of background identifier 502.

Background identifier 502 acquires, from image acquirer 101, a camera image captured at a first timing (hereinafter, camera image A), and sets a first reference position in the camera image A (Step S601). Background identifier 502 sets the first reference position in the same manner as in the first exemplary embodiment.

Background identifier 502 determines the search straight line in the same manner as in the first exemplary embodiment (Step S602). More specifically, background identifier 502 determines the straight line passing through the reference position and the vanishing point to be the search straight line. The search straight line is common to the camera images A and B.

Background identifier 502 regards the correlation between a plurality of groups of pixels contiguous to a plurality of pixels respectively, as the correlation between the plurality of pixels. Background identifier 502 first extracts the pixel at the reference position and a plurality of pixels which are contiguous to the reference position in the camera image A and exist on the search straight line. The hereinafter, the pixel at the reference position and the plurality of pixels which are contiguous to the reference position are referred as first group of pixels. For example, background identifier 502 extracts eight pixels existing in the direction toward the vanishing point from the reference position on the search straight line (Step S603).

Background identifier 502 acquires, from image acquirer 101, the second camera image captured later than the first timing (hereinafter, camera image B). Background identifier 502 then calculates the correlation between the reference position in the camera image A and the reference position in the camera image B. The correlation is calculated while shifting the position in the camera image B that corresponds to the reference position in the camera image A, or in other words, shifting the reference position in the camera image B toward the vanishing point on the search straight line (Step S604).

More specifically, background identifier 502 extracts a plurality of pixels which are contiguous to the reference position in the camera image B and exist on the search straight line and the pixel at the reference position (hereinafter, “second group of pixels”) in the same manner as the first group of pixels. Background identifier 502 then calculates the correlation between the first and second groups of pixels. The correlation value calculated by background identifier 502 is, for example, a sum of absolute difference (SAD). Background identifier 502 then calculates the correlation between the first and second groups of pixels, or the correlation between the reference position in the camera image A and the reference position in the camera image B while shifting the extract position of the second group of pixels, or the reference position in the camera image B toward the vanishing point along the search straight line.

Assume that the second group of pixels having a correlation of not less than a specified value (e.g., not less than 0.8) with the first group of pixels exists on the position obtained by shifting the reference position in the camera image B toward the vanishing point along the search straight line (YES in Step S605). In this case, background identifier 502 determines that the reference position in the camera image B obtained when the second group of pixels is extracted is the background. In short, background identifier 502 determines the second pixel to be the background (Step S606). If there is no pixel having a correlation of not less than the specified value (NO in Step S605), the process proceeds to Step S607. Background identifier 502 stores the position of the second pixel in the camera image B to a storage unit (not shown).

If the camera image A contains no other position to be referred to (NO in Step S607), background identifier 502 terminates the background specification process based on the vanishing point.

If the camera image A contains another position to be referred to or another pixel to determine whether it is the background or not (YES in Step S607), background identifier 502 sets a next reference position in the camera image A (Step S608), and repeats the processes from Step S602.

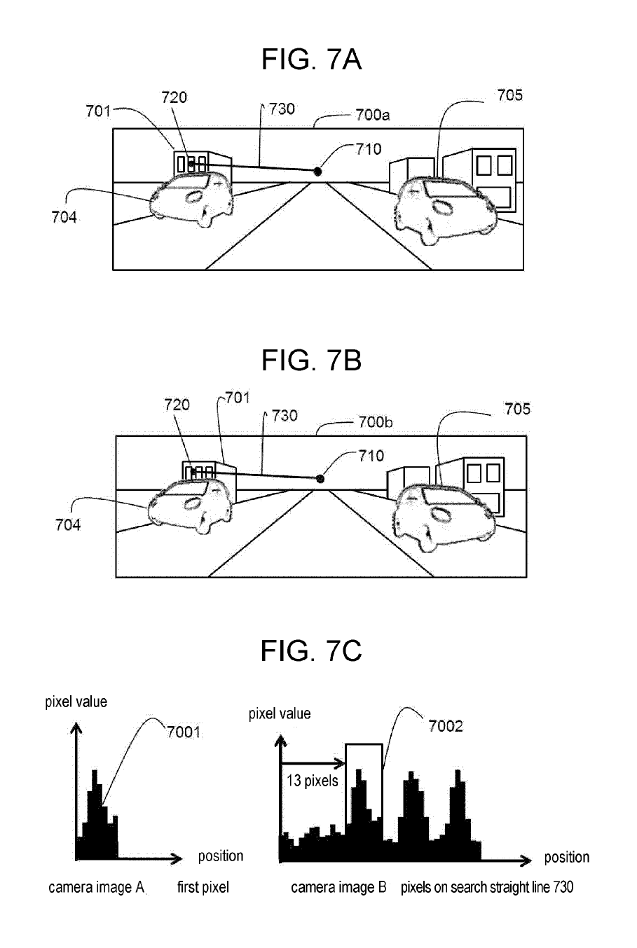

FIGS. 7A to 7C show processes of background identifier 502.

FIG. 7A shows a camera image captured at a first timing (the camera image A). Camera image 700a is identical to camera image 300 shown in FIG. 3A, and contains vehicles 704 and 705, building 701, and the like. In camera image 700a, search straight line 730 passes through reference position 720 and vanishing point 710. Background identifier 502 extracts the eight pixels existing on search straight line 730 and the pixel at the reference position as the first group of pixels from reference position 720 toward vanishing point 710.

FIG. 7B shows a second camera image captured later than the first timing (the camera image B). In camera image 700b, the captured position of building 701 is shifted to the vanishing point from the position in camera image 700a. Reference position 720 shows an end of building 701.

Background identifier 502 calculates the correlation between the first group of pixels and a group of pixels on search straight line 730 in the camera image B while shifting reference position 720 in the camera image B toward vanishing point 710.

FIG. 7C shows the pixel values of the first group of pixels in the camera image A and those of the pixels on search straight line 730 in the camera image B. The horizontal axis represents positions on search straight line 730. The left end corresponds to reference position 720, and the rightward direction is toward the vanishing point along the horizontal axis. The vertical axis represents pixel values.

Background identifier 502 calculates the correlation between first group of pixels 7001 in the camera image A and the second group of pixels existing on search straight line 730 in camera image B. The second group of pixels is obtained by shifting one pixel toward the vanishing point from reference position 720. Background identifier 502 then compares the correlation with the specified value (e.g., 0.8). When the correlation is not more than the specified value, background identifier 502 calculates the correlation with the group of pixels obtained by shifting one more pixel, and compares the calculated correlation with the specified value. Background identifier 502 repeats the above-described processes until finding a group of pixels having a correlation of not less than the specified value. If the camera image B contains a group of pixels having a correlation of not less than the specified value before the reference position in the camera image B reaches the vanishing point 710, background identifier 502 determines the reference position in camera image B obtained when the group of pixels is extracted to be the background.

In FIG. 7C, the correlation with group of pixels 7002 extracted when reference position 720 in the camera image B is shifted 13 pixels toward the vanishing point is not less than the specified value. Therefore, background identifier 502 determines the position (the second pixel) shifted 13 pixels toward the vanishing point from the initial reference position 720 in the camera image B to be the background. Background identifier 502 then stores the position of the second pixel contained in the camera image B.

Background identifier 502 sets the reference positions for all pixels in camera image A and determines whether each pixel is the background or not.

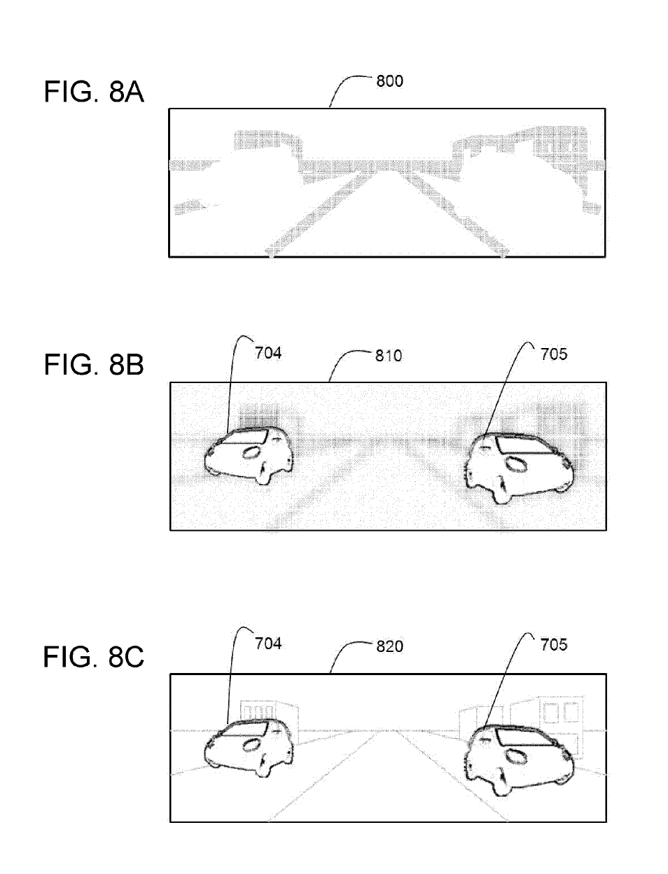

FIGS. 8A to 8C show processes of background processor 103 in the second exemplary embodiment.

FIG. 8A shows the background in the camera image B specified by background identifier 502. Background identifier 502 stores the positions of the pixels in the camera image B that have been determined to be the background in the storage unit (not shown). The gray regions in camera image 800 represent the background regions in the camera image B stored in background identifier 502.

Background processor 103 applies background processing to the background specified by background identifier 502 so as to reduce the clarity of the background. Background processor 103 reduces the high-frequency components using a low-pass filter or reduces the contrast by adjusting the gradation, as the background processing, for example.

FIG. 8B shows a camera image obtained by reducing the high-frequency components in the background regions in FIG. 8A using a low-pass filter. FIG. 8C shows a camera image obtained by adjusting the gradation of the background regions in FIG. 8A, thereby reducing the contrast of the background regions.

Display unit 104 displays background-processed camera image 810 or 820.

In both camera images 810 and 820, background processor 103 reduces the clarity of the background, thereby increasing the visibility of vehicles 704 and 705 as the mobile objects.

As shown in FIGS. 7A and 7B, the positions of the pixels composing the contours of objects moving away from the own vehicle in the image captured at the first timing are shifted toward the vanishing point in an image captured at a second timing later than the first timing. Therefore, background identifier 502 determines the pixels whose positions in the image captured at the first timing are shifted toward the vanishing point in the image captured at the second timing to be the background. Background processor 103 reduces the clarity of the background, thereby increasing the visibility of mobile objects.

Furthermore, background identifier 502 uses two images captured at different timings, and determines whether or not the pixels composing the contours of the objects common to the two images shifts to the vanishing point in the image captured at the later timing than in the image captured at the earlier timing. If so, background identifier 102 determines the pixels to be the background. As a result, vehicles 704 and 705 as the mobile objects have higher visibility than in a camera image in which edges are used as the background, such as camera images 410 and 420 shown in FIGS. 4B and 4C, respectively, in the first exemplary embodiment.

As described above, vehicle-mounted display device 500 includes background identifier 502, background processor 103, and display unit 104. Background identifier 502 specifies the background of the camera image captured by camera 110 mounted in the vehicle based on the vanishing point of the camera image. Background processor 103 performs background processing to reduce the clarity of the background specified by background identifier 502. Display unit 104 displays the camera image background-processed by background processor 103. Background identifier 502 specifies as the background the second pixel having a correlation of not less than a given value with the first pixel. The first pixel exists on the straight line passing through the vanishing point in the first camera image captured at the first timing. The second pixel exists at a position closer to the vanishing point in the second camera image than the position of the first pixel existing on the straight line passing through the vanishing point. The second camera image is captured later than the first timing. In vehicle-mounted display device 500, objects shifting to the vanishing point in the camera image captured at the later timing from the position in the camera image captured at the earlier timing are determined to be the background, and the clarity of the background is reduced to increase the visibility of mobile objects.

The correlation between the first group of pixels and the group of pixels on search straight line 730 can be calculated by other methods than that described in the exemplary embodiments.

Background identifier 502 extracts, as the target to calculate the correlation, a group of pixels contiguous from the reference position toward the vanishing point. Background identifier 502 may alternatively extract a group of pixels contiguous from the reference position toward the direction opposite to the vanishing point. Background identifier 502 may further alternatively extract a group of pixels contiguous from the reference position toward the vanishing point as well as a group of pixels contiguous from the reference position toward the direction opposite to the vanishing point.

Vehicle-mounted display device 500 can be achieved by dedicated hardware implementation. Alternatively, however, it is possible to store a program to implement the function in a computer-readable recording medium, to read the stored program into computer system, and to execute it.

### Third Exemplary Embodiment

A vehicle-mounted display device according to a third exemplary embodiment of the present disclosure will now be described as follows.

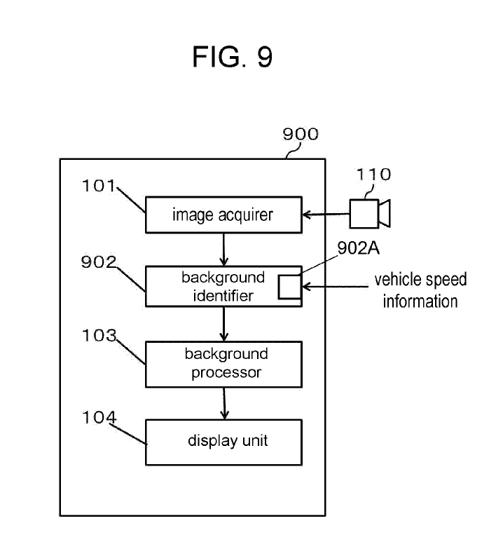

FIG. 9 is a block diagram showing the configuration of vehicle-mounted display device 900 according to the present exemplary embodiment.

In the present exemplary embodiment, the same components as in the second exemplary embodiment are denoted by the same reference numerals, and thus a detailed description thereof is omitted.

The present exemplary embodiment differs from the second exemplary embodiment in that the present exemplary embodiment includes background identifier 902 which includes speed information receptor 902A for receiving speed information of the vehicle, and that the speed information is used to determine the search range of the second pixel.

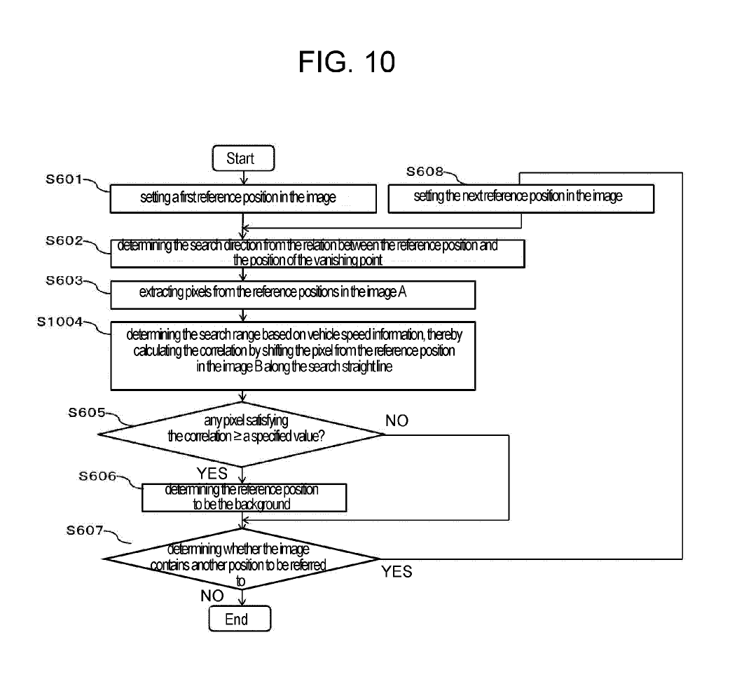

FIG. 10 is a flowchart of the operation of background identifier 902. In FIG. 10, the same steps as in the flowchart shown in FIG. 6 in the second exemplary embodiment are denoted by the same step numbers, and thus a detailed description thereof is omitted.

FIG. 10 differs from FIG. 6 in including Step S1004 instead of Step S604 shown in FIG. 6. In Step S1004, background identifier 902 determines the search range of the second pixel based on vehicle speed information (e.g., the speed of the own vehicle detected when the camera image B is captured), thereby calculating the correlation between the first group of pixels and the group of pixels in the search range.

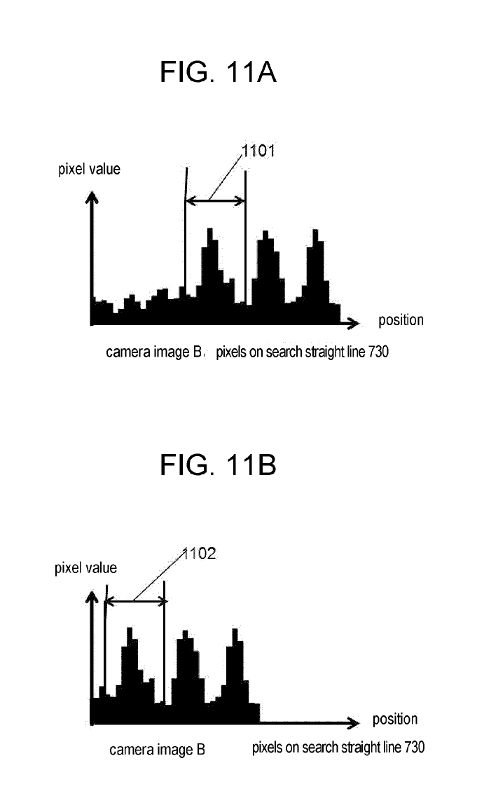

FIGS. 11A and 11B show search ranges determined by background identifier 902 based on the speed of the own vehicle. In FIGS. 11A and 11B, the horizontal axis represents positions on search straight line 730 shown in FIGS. 7A and 7B. The left end corresponds to reference position 720, and the rightward direction is toward the vanishing point. The vertical axis represents pixel values.

FIG. 11A shows a search range in an image captured when the vehicle speed is higher than in FIG. 11B. When the own vehicle runs fast, the background has a large change in position between the camera images A and B. In such a case, background identifier 902 determines, for example, a range from the 18th to 28th pixels to be search range 1101 based on the vehicle speed. The 18th pixel is 17 pixels away from reference position 720. Background identifier 902 then calculates the correlation between the group of pixels in search range 1101 and the first group of pixels (shown in FIG. 7C).

FIG. 11B shows a search range in an image captured when the vehicle speed is lower than in FIG. 11A. When the own vehicle runs slow, the background has a small change in position between camera images A and B. In such a case, background identifier 902 determines, for example, a range from the 3rd to 13th pixels to be search range 1102 based on the vehicle speed. The 3rd pixel is two pixels away from the reference position. Background identifier 902 then calculates the correlation between the group of pixels in search range 1102 and the first group of pixels (shown in FIG. 7C).

As described above, the search range of the second pixel can be determined based on the speed of the own vehicle so as to facilitate the search of the background and to prevent erroneous determination of the background.

In the case of not determining the search range, if a plurality of pixels of not less than a specified value exist on search straight line 730, when the vehicle speed is high, background identifier 902 is likely to erroneously determine a pixel near reference position 720 to be the second pixel. Meanwhile, in the case of setting the search range based on the vehicle speed, background identifier 902 can determine the pixel in the search range closest to vanishing point 710 to be the second pixel.

As described above, vehicle-mounted display device 900 includes background identifier 902, background processor 103, and display unit 104. Background identifier 902 specifies the background of a camera image captured by camera 110 mounted in the vehicle based on the vanishing point of a camera image. Background processor 103 performs background processing to reduce the clarity of the background specified by background identifier 902. Display unit 104 displays the camera image background-processed by background processor 103. Background identifier 902 specifies as the background the second pixel having a correlation of not less than a given value with the first pixel. The first pixel exists on the straight line passing through the vanishing point in the first camera image captured at the first timing. The second pixel exists in the range, determined based on the vehicle speed, on the straight line passing through the vanishing point in the second camera image captured later than the first timing. Vehicle-mounted display device 900 can efficiently and accurately determine that objects moving toward the vanishing point are the background, and decrease the clarity of the background, thereby improving the visibility of mobile objects.

The vehicle speed has so far been used to determine the position of the search range alone, but may also be used to determine the length of the search range. For example, when the vehicle speed is low, the search range can be set narrow, whereas when the vehicle speed is high, the search range can be set wide, so that the second pixel can be searched more efficiently.

The vehicle-mounted display device according to the present exemplary embodiment can be achieved by dedicated hardware implementation. Alternatively, however, it is possible to store a program to implement the function in a computer-readable recording medium, to read the stored program into computer system, and to execute it.

The vehicle-mounted display device, the method of controlling the vehicle-mounted display device, and the computer readable medium recording the program according to the present disclosure are highly useful for an electric mirror for vehicles.

What is claimed is:

1. A vehicle-mounted display device comprising:
a background identifier which specifies a background of a camera image based on a vanishing point in the camera image, the camera image being captured by a camera mounted in a vehicle;
a background processor which performs background processing to reduce clarity of the background specified by the background identifier; and
a display unit which displays the camera image background-processed by the background processor.

2. The vehicle-mounted display device according to claim 1,
wherein the background identifier specifies, as the background, an edge existing on a straight line passing through the vanishing point and having a slope agreeing with a slope of the straight line passing through the vanishing point.

3. The vehicle-mounted display device according to claim 1,
wherein a first pixel exists on a straight line passing through a vanishing point in a first camera image captured at a first timing,
a second pixel exists at a position shifted from a position of the first pixel existing on the straight line passing through the vanishing point in a second camera image captured later than the first timing to the vanishing point in the second camera image, and
the background identifier specifies, as the background, the second pixel having a correlation of a given value or more with the first pixel.

4. The vehicle-mounted display device according to claim 3,
wherein the second pixel is one of a plurality of second pixels, and the background identifier specifies, as the background, a certain number of the plurality of second pixels that are in a predetermined range on the straight line passing through the vanishing point in the second camera image.

5. The vehicle-mounted display device according to claim 4,
wherein the background identifier includes a speed information receptor which receives speed information of the vehicle, and the background identifier determines the predetermined range on the straight line based on the speed information of the vehicle received by the speed information receptor.

6. The vehicle-mounted display device according to claim 1,
wherein the display unit is installed in a position inside the vehicle, the position being where a rearview mirror is attached.

7. The vehicle-mounted display device according to claim 1,
wherein the background processor reduces clarity of the background either by reducing high-frequency components using a low-pass filter or by reducing a contrast by adjusting gradation.

8. A method of controlling a vehicle-mounted display device for displaying on a display unit an image captured by a camera mounted in a vehicle, the method comprising:
specifying a background of a camera image based on a vanishing point of the camera image;
reducing clarity of the specified background; and
displaying the camera image with reduced clarity.

9. The method according to claim 8,
wherein the specifying the background of the camera image based on the vanishing point of the camera image includes:
calculating a correlation between a first pixel and a second pixel; and
determining whether the second pixel is the background based on the calculated correlation between the first pixel and the second pixel,
where the first pixel exists on a straight line passing through a vanishing point in a first camera image captured at a first timing, and the second pixel exists at a position shifted from a position of the first pixel existing on the straight line passing through the vanishing point in a second camera image captured later than the first timing to the vanishing point in the second camera image.

10. A non-transitory computer readable medium recording a program for executing the method of controlling the vehicle-mounted display device as defined in claim 8 on a computer.
